(19) United States
(12) Patent Application Publication
(10) Pub. No.: US 2002/0104038 A1
(43) Pub. Date: Aug. 1, 2002

(54) Redundant disks in a removable magnetic storage device and method of implementing the same

(75) Inventor: Brent Jay Harmer, Ogden, UT (US)

Correspondence Address: Steven L. Nichols, Parsons Behle & Latimer, One Utah Center, 201 South Main Street, Suite 1800, Salt Lake City, UT, 84145-0898, US

(73) Assignee: Iomega Corporation

(21) Appl. No.: 09/775,096

(22) Filed: Feb. 1, 2001

(51) Int. Cl. G06F 11/08

(52) U.S. Cl. 714/6

(57) ABSTRACT

A removable data storage medium for a computer or other data processing device contains at least two data storage disks, a master disk and a backup disk, housed in a single cartridge. All data stored on the device is written to both the master and backup disk. Consequently, the data storage is more reliable because two copies of the data are maintained. The second copy of the data can be used to correct errors or corruption occurring in the first copy, and vice versa.

### FIELD OF THE INVENTION

The present invention relates to the field of removable magnetic storage devices for computer data. More particularly, the present invention relates to a removable magnetic storage device for storing computer data that includes multiple storage disks on which two copies, a master copy and a backup copy, of all information stored on the device are maintained.

### BACKGROUND OF THE INVENTION

Computers are widely used in business and personal life for an incredible variety of purposes. Computers can be used in generating documents, keeping financial and other records, providing business and personal communications, researching information, etc. Computers make possible our growing global economy and society, and consequent achievements.

The capacity of a computer to store data increases regularly. At present, data is stored primarily on the computer's hard drive, an internal magnetic disk. Additionally, data is often stored on a removable disk, e.g., a magnetic floppy disk or an optical disc. Such removable storage media expand the amount of data that can be stored and made available to the computer as needed. Removable storage media are also a convenient means of transferring data between different computers.

At present, removable storage media are primarily magnetic disks, such as floppy disks, and optical disks, such as writable compact discs and rewritable compact discs. Magneto-optical disks as a data storage device are also known.

Despite the various advantages provided by removable storage media, there are also some disadvantages. Data tends to be less secure on a removable storage media than on a computer's internal hard drive. Because removable storage media are transportable, they may be subject to temperature extremes, magnetic fields, scratches, dust, spilled liquids, physical damage, etc.. Consequently, data is more likely to become corrupted or lost on a removable storage media, particularly on removable magnetic storage media, than on the computer's internal hard drive. The computer's internal hard drive remains safely encased in the computer's housing.

Consequently, there is a need in the art for a method and system for more reliably storing data on a removable data storage medium. More particularly, there is a need in the art for a method and system of more reliably storing data on a removable data storage medium that can be read by a computer to expand the volume of data available to the computer.

### SUMMARY OF THE INVENTION

The present invention meets the above-described needs and others. Specifically, the present invention provides a method and system for more reliably storing data on a removable data storage medium. More particularly, the present invention provides a more reliable data storage medium that can be read by a computer to expand the volume of data available to the computer.

Additional advantages and novel features of the invention will be set forth in the description which follows or may be learned by those skilled in the art through reading these materials or practicing the invention. The advantages of the invention may be achieved through the means recited in the attached claims.

The present invention may be embodied and described as a removable data storage device that includes a master data storage disk rotatably mounted in a cartridge, and a backup data storage disk rotatably mounted in the same cartridge. The master and backup data storage disks may be magnetic data storage disks. Alternatively, the master and backup data storage disks may be optical data storage disks. If more storage capacity is needed, there may be two or more master data storage disks and a corresponding number of backup data storage disks, all rotatably mounted in the cartridge.

The present invention may also be embodied in a system for using the multi-disk removable data storage device described above. For example, the present invention may be described as a system for storing electronic data, the system including: a removable data storage device that includes a master data storage disk rotatably mounted in a cartridge, and a backup data storage disk rotatably mounted in the cartridge; and a disk drive for reading data from and writing data to the removable data storage device. The disk drive may be connected to a host computer, or integrated into a host computer.

Preferably, the disk drive includes firmware that causes the disk drive, when not receiving data or commands from a host device, to read and compare corresponding data stored on the master and backup disks. In such a case, the firmware also causes the disk drive to correct errors discovered in the data on the master or backup disk using corresponding data on the other disk. Preferably, the firmware causes the disk drive to read and compare the data, and corrects any errors discovered automatically.

The present invention also encompasses the methods of making and using the system and removable data storage device described above. Specifically, the present invention also encompasses a method of storing electronic data on a removable data storage device that has a master data storage disk rotatably mounted in a cartridge, and a backup data storage disk rotatably mounted in the same cartridge. The method includes writing a first copy of data received from a host device to the master disk and writing a second copy of the data to the backup disk.

The method of the present invention may also include reading data from the master disk; reading corresponding data from the backup disk; and comparing the data from the master disk and the backup disk. Preferably, the reading and comparing of the data is performed automatically when the disk drive is not receiving data or commands from a host device. After this procedure, the method may include identifying errors in data stored on the master and backup disks; and correcting errors in the data stored on the master or backup disk using corresponding data on the other disk.

### BRIEF DESCRIPTION OF THE DRAWINGS

The accompanying drawings illustrate the present invention and are a part of the specification. Together with the following description, the drawings demonstrate and explain the principles of the present invention.

FIG. 1 is a diagram of a novel removable storage medium and corresponding disk drive according to the principles of the present invention.

FIG. 2 is a diagram of a second embodiment of the novel removable storage medium and corresponding disk drive according to the principles of the present invention.

FIGS. 3a and 3b are a flowchart illustrating a preferred method of the present invention.

### DETAILED DESCRIBPTION OF THE PREFERRED EMOBODIMENTS

Under the principles of the present invention, a removable data storage medium for a computer or other data processing device contains at least two data storage disks, a master disk and a backup disk. All data stored on the medium is written to both the master and backup disk. Consequently, the data storage is more reliable because two copies of the data are maintained. The second copy of the data can be used to correct errors or corruption occurring in the first copy, and vice versa.

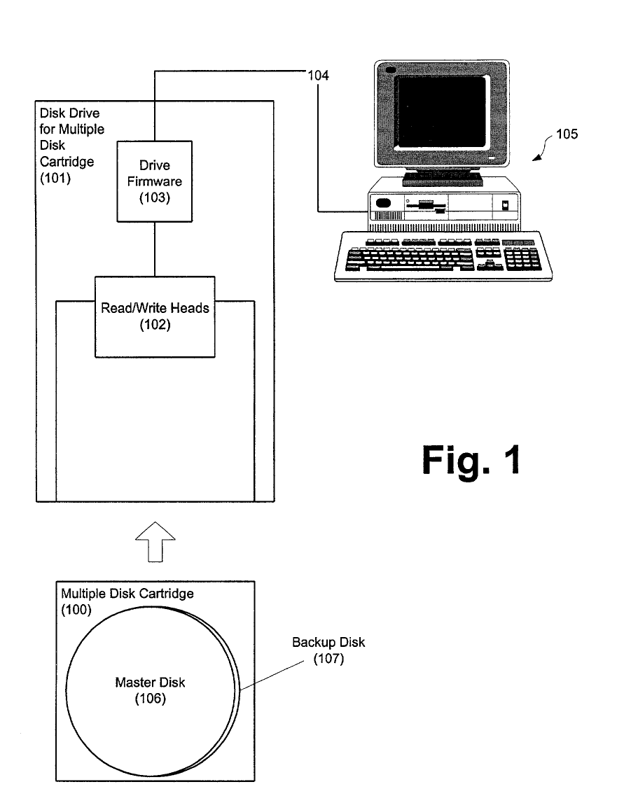

Using the drawings, the preferred embodiments of the present invention will now be explained. FIG. 1 is a diagram of a first embodiment of a multi-disk removable storage medium and corresponding disk drive according to the principles of the present invention. This storage medium and corresponding disk drive may be used to store data from and provide data to any electronic data processing system, particularly, a personal or other computer.

As used herein, the term “disk drive” is used to refer, not to a conventional floppy disk or CD-ROM drive, but to a disk drive according to the present invention which is designed and capable of reading data from and writing data to a removable data storage device containing multiple data storage disks.

As shown in FIG. 1, the present invention may be implemented in or with a computer (105). This computer (105) may be any type of computer, including, but not limited to, a personal computer, a server, an Apple® computer, a desktop computer, a laptop computer, etc. The computer (105) may be a stand-alone computer or maybe networked in a Local or Wide Area Network (LAN or WAN). The computer (105) may also be connected to the Internet or any other computer network.

The present invention includes, primarily, a novel data storage medium (100) and a corresponding disk drive (101) for reading data from and writing data to the data storage medium (100). The disk drive (101) may be integrated into the computer (105), in the same manner as a conventional floppy disk drive. The disk drive (101) may also be external to the computer (105) and connected to the computer (105) by a data connection (104).

The data storage medium (100) is a cartridge or housing (120) containing at least two data storage disks (106, 107). The data storage disks (106, 107) may be magnetic disks, optical disks or any other data storage medium. If the data storage disks (106, 107) are magnetic disks, the data storage cartridge (100) becomes similar to a number of floppy disks integrated into a single housing. Similarly, the data storage cartridge (100) may be a cartridge that houses two or more rewritable optical disks.

The first disk (106) in the cartridge (100) may be referred to as the master disk (106). The second disk (107) in the cartridge (100) may be referred to as the backup disk (107). The cartridge (100) may include a window therein (not shown) which may be covered by a biased shutter (not shown). Through the window, the disks (106, 107) can be accessed by the read/write head or heads (102) of a disk drive (101).

When the cartridge (100) is inserted in the disk drive (101) of the present invention, the read/write heads (102) come into proximity with and have access to all the disks (106, 107) contained in the cartridge (100). The read/write heads (102) are then able to write data to or read data from either disk (106, 107) in the cartridge (100).

If the disks (106, 107) are magnetic disks, the read/write head (102) will be a magnetic read/write head. If the disks (106, 107) are rewritable optical disks, the read/write head (102) will contain an optical pickup with a modulated laser for writing data to or reading data from either of the disks (106, 107).

When data is received from the computer (105) for storage, the read/write heads (102) are controlled by the firmware (103) stored in the disk drive (101) to write the incoming data to the master disk (106). Similarly, if the computer (105) signals a need for data from the cartridge (100), the firmware (103) controls the read/write heads (102) to retrieve the requested data from the master disk (106).

In order to further address the problems of the prior art and render more reliable the data stored on the cartridge (100) of the present invention, all data stored on the removable data storage medium (100) is written to both the master disk (106) and the backup disk (107). Preferably, this duplication of information is performed automatically by the drive firmware (103) without intervention from or placing additional demands on the computer (105).

For example, data is sent from the computer (105) to the disk drive (101) in the same manner that a computer sends data for storage to a conventional hard drive, a floppy disk drive or a rewritable compact disk drive. The data is received, and may be buffered, in the drive firmware (103). The drive firmware (103) controls the read/write heads (102) to write the data to the master disk (106).

When the data has been written to the master disk (106), the drive firmware (103), preferably without additional commands from the computer (105), controls the read/write heads (102) to write the same data to the backup disk (107). Thus, the data stored on the backup disk (107) is a mirror image of the data stored on the master disk (106).

The drive firmware (103) may contain a buffer which holds data as the data is written to both the master (106) and backup (107) disks. In such a case, the computer (105) may send data for storage in discrete packages matching the size of the buffer in the drive firmware (103). Alternatively, the drive firmware (103) may write all incoming data to the master disk (107) and then read the data from the master disk (106), buffering as necessary, and write the data to the backup disk (107). This approach may minimize the time required in which the computer (105) is interfacing with the disk drive (101) and, therefore, decrease the demands placed on the computer (105) by the disk drive (101).

When the computer (105) is not sending data to or having data read from the multiple disk cartridge (100), the drive firmware (103) may be ensuring the integrity of the stored on the cartridge (100). Specifically, the drive firmware (103), when not occupied by commands from the computer (105), may continuously read matching data from the master (106) and backup (107) disks. The data so read is then compared to ensure that no errors or discrepancies remain in the data stored on the cartridge (100). As will be described in more detail below, if an error or errors are found in either copy of the data, the other, uncorrupted copy of the data can be used to repair the erroneous copy.

While not explicitly illustrated in detail, the disk drive (101) also contains those mechanisms needed to perform the tasks described above. For example, the disk drive (101) may include a spindle motor to rotate the disks (106, 107) which are rotatably mounted in the cartridge (100) so that the read/write heads (102) can access all parts of the disks (106, 107). The drive (101) may also include one or more servo motors for moving the read/write heads (102) within the drive (100) to facilitate the head's access to all parts of the disks (106, 107). Finally, the drive (100) may also include mechanisms for ejecting the cartridge (100) from the drive (101) upon a signal from the computer (105) or the actuation of an ejection control on the drive (101) itself.

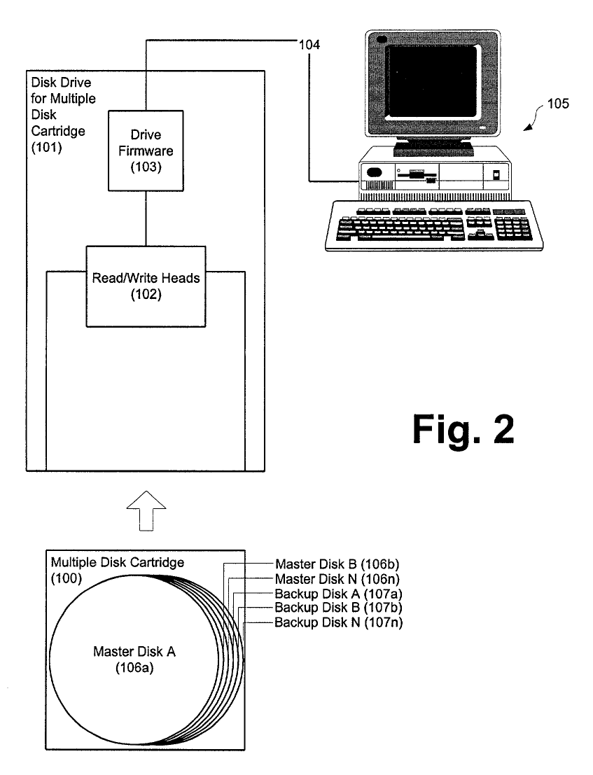

FIG. 2 illustrates a second embodiment of a removable data storage device and corresponding disk drive according to the present invention. The embodiment illustrated in FIG. 2 is, in many respects, identical to that illustrated in FIG. 1. Identical elements in the drawings have been given identical reference numbers. Consequently, redundant explanations of elements already described may be omitted in the discussion of FIG. 2.

As shown in FIG. 2, the multiple disk cartridge (100) of the present invention need not contain only a single master disk and a single backup disk. Rather, the cartridge (100) may house multiple master disks and a multiple backup disks to provide any data storage capacity desired for the cartridge (100).

For example, in the embodiment shown in FIG. 2, the cartridge (100) houses at least three master disks (106a, 106b, 106n) and at least three backup disks (107a, 107b, 107n). Those skilled in the art will understand that there is no theoretical limit to the number of disks included in the cartridge (100). Preferably, the number of backup disks, or the capacity thereof, will match the number of mater disks, or the capacity thereof, so that two complete copies of the data committed to the cartridge (100) may be maintained, one on the master disks (106) and one on the backup disks (107).

The read/write heads (102) of the disk drive (101) and the servos that position the heads will be appropriately adapted to provide access to all data-bearing parts of all the various disks (106, 107) in the multiple disk cartridge (100). Naturally, the cartridge (100) may be increased in size to accommodate an increased number of disks housed therein.

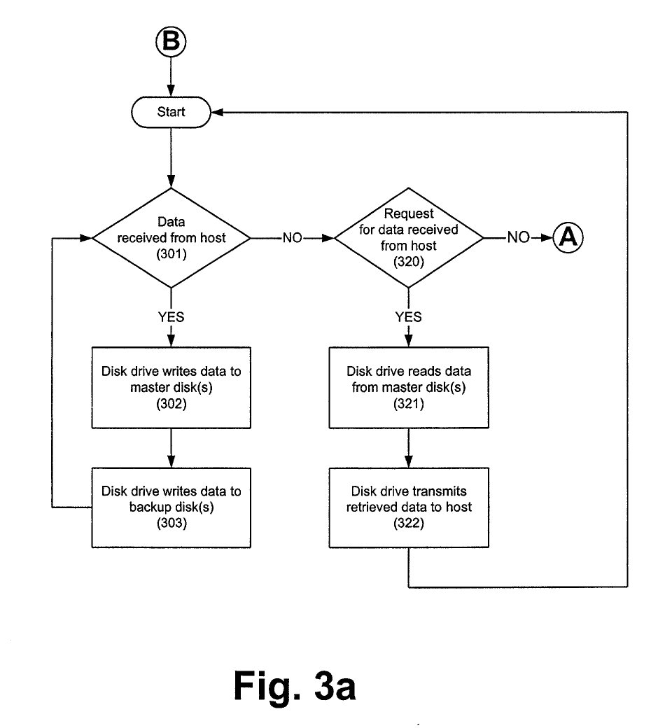

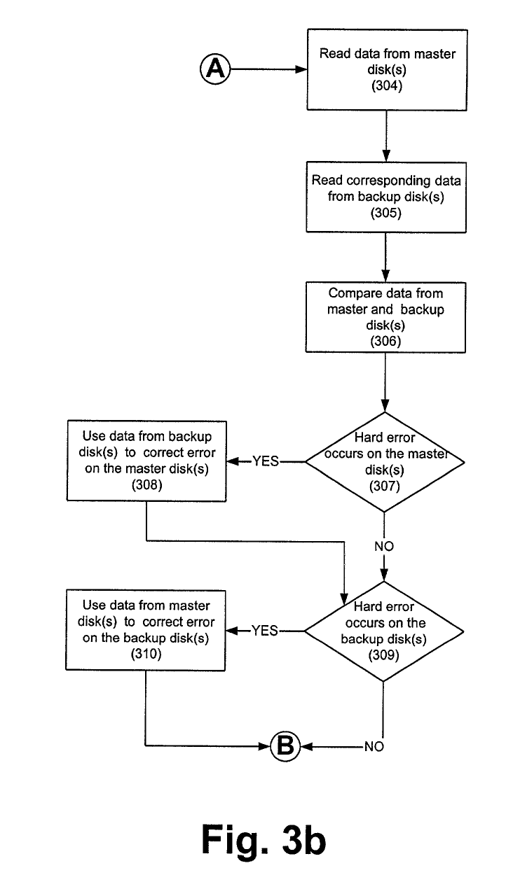

FIG. 3, comprising FIGS. 3a and 3b, is a flowchart illustrating a preferred method of the present invention. As shown in FIG. 3a, data may be sent from the host computer for storage by the disk drive of the present invention on the removable data storage medium of the present invention (301). If data is received, from the host, the disk drive writes the data to the master disk or disks (302). The disk drive then writes the data to the backup disk or disks (303).

If no data for storage is received from the host, the host may alternatively be sending read commands to the disk drive to retrieve data stored on the multiple disk storage device of the present invention (302). If such a read command is received, the disk drive of the present invention will appropriately read the indicated data from the master disk or disks (321) and transmit that data to the host (322).

If no data for storage is received from the host, and no read commands are received from the host, the disk drive is idle. During such a period, as shown in FIG. 3b, the system of the present invention uses the two copies of data stored on the removable data storage medium to verify and enhance the integrity of the data stored.

As shown in FIG. 3b, when the disk drive is idle, i.e., is not serving the needs of the host device, the disk drive reads data from the master disk or disks (304). Corresponding data is also read from the additional copy of the data on the backup disks (305). The data from the master and backup disk or disks is then compared to look for data errors (306).

If a hard error occurs in the data read from the master disk or disks (307), the corresponding data from the backup disk or disks is used to rewrite the corrupted data correctly on the master disk or disks (308). Similarly, if a hard error occurs in the data read from the backup disk or disks (309), the corresponding data from the master disk or disks is used to rewrite the corrupted data correctly on the backup disk or disks (310).

This process preferably occurs automatically without any intervention from the host device. Rather, the process outlined in FIG. 3b is a function of the firmware of the disk drive of the present invention. Consequently, the integrity of the data on the removable data storage cartridge of the present invention is assured by continual checking and re-checking with two complete copies of the data being maintained on the removable data storage cartridge.

It will be understood also by those skilled in the art that the data comparision and error removal process described above need not occur constantly during idle periods of the disk drive. Rather, the firmware of the disk drive may be programmed to make periodic comparisons of the two data sets stored and correct any errors found.

With the present invention, data stored on a removable data storage cartridge may be as reliable as data stored on computer's internal hard drive. Consequently, the data storage capacity associated with the computer becomes virtually unlimited.

The present invention also encompasses the programming or electronic instructions required to cause the disk drive described above to function in the manner described. Specifically, the present invention encompasses any software, coding or logic circuitry incorporated into the firmware of the disk drive. The flowcharts of FIG. 3 may be considered as providing a detailed explanation of such programming.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A removable data storage device comprising:
a master data storage disk rotatably mounted in a cartridge; and a
backup data storage disk rotatably mounted in said cartridge.

2. The data storage device of claim 1, wherein said master and backup data storage disks are magnetic data storage disks.

3. The data storage device of claim 1, wherein said master and backup data storage disks are optical data storage disks.

4. The data storage device of claim 1, further comprising a plurality of master data storage disks and a corresponding plurality of backup data storage disks, all said data storage disks being rotatably mounted in said cartridge.

5. A system for storing electronic data, said system comprising: a removable data storage device that comprises a master data storage disk rotatably mounted in a cartridge, and a backup data storage disk rotatably mounted in said cartridge; and
a disk drive for reading data from and writing data to said removable data storage device.

6. The system of claim 5, wherein said disk drive is connected to a host computer.

7. The system of claim 5, wherein said disk drive is integrated into a host computer.

8. The system of claim 5, wherein said disk drive comprises firmware that causes said disk drive, when not receiving data or commands from a host device, to read and compare corresponding data stored on said master and backup disks.

9. The system of claim 8, wherein said firmware further causes said disk drive to correct errors discovered in data on said master or backup disk using corresponding data on the other of said master or backup disk.

10. The system of claim 8, wherein said firmware causes said disk drive to read and compare said data automatically.

11. A method of storing electronic data on a removable data storage device that comprises a master data storage disk rotatably mounted in a cartridge, and a backup data storage disk rotatably mounted in said cartridge, said method comprising wirting a first copy of data received from a host device to said master disk and writing a second copy of said data to said backup disk.

12. The method of claim 1 1, further comprising:
reading data from said master disk;
reading corresponding data from said backup disk; and
comparing said data from said master disk and said backup disk.

13. The method of claim 12, wherein said reading and comparing data is performed automatically when not receiving data or commands from a host device.

14. The method of claim 12, further comprising:
Identifying errors in data stored on said master and backup disks; and
correcting errors in the data stored on said master or backup disk using corresponding data on the other of said master or backup disk.

15. A system for storing electronic data, said system comprising:
a removable data storage means that comprises a master data storage means mounted in a cartridge, and a backup data storage means also mounted in said cartridge; and
read/write means for reading data from and writing data to said removable data storage means.

16. The system of claim 15, wherein said read/write means are connected to a host computer.

17. The system of claim 15, wherein said read/write means are integrated into a host computer.

18. The system of claim 15, wherein said read/write means, when not receiving data or commands from a host device, read and compare corresponding data stored on said master and backup data storage means.

19. The system of claim 18, wherein said read/write means correct errors discovered in data on said mater or backup data storage means using corresponding data on the other of said master or backup data storage means.

20. The system of claim 18, wherein said read/write means read and compare said data automatically.
